(19) United States
(12) Patent Application Publication
(10) Pub. No.: US 2019/0096603 A1
(43) Pub. Date: Mar. 28, 2019

(54) COMPUTING DEVICE WITH OFFSET BUTTON AND SWITCH

(71) Applicant: Microsoft Technology Licensing, LLC, Redmond, WA (US)

(72) Inventors: Nathan Michael THOME, Kirkland, WA (US); Joseph Benjamin GAULT, Seattle, WA (US)

(21) Appl. No.: 15/715,884

(22) Filed: Sep. 26, 2017

(51) Int. Cl. H01H 13/52; H01H 13/705; H01H 15/10

(52) U.S. Cl. CPC H01H 13/52; H01H 13/705; H01H 2221/08; H01H 2221/062; H01H 2221/064; H01H 15/10

(57) ABSTRACT

A computing device may include a housing with an aperture. A switch with an activation surface is connected to the housing. A button may be slidable within the aperture and may be configured to receive an activation force from a user to activate the switch. The button may be moveable to activate the switch. The button may have a back surface that is offset from the activation surface of the switch such that when the button is moved to the active position the activation surface and the back surface do not come into direct contact. An adapter may be positioned between the switch and the button, where the adapter has a switch surface and a button surface. The button surface may be aligned with the back surface of the button and the switch surface may be aligned with the activation surface of the switch.

### BACKGROUND

### Background and Relevant Art

Use of computing devices is becoming more ubiquitous by the day. Computing devices range from standard desktop computers to wearable computing technology and beyond. One area of computing devices that has grown in recent years is the hybrid computer. Hybrid computers may act as a tablet computer or a laptop computer. Many hybrid computers include input devices that may be separated from the screen.

The subject matter claimed herein is not limited to implementations that solve any disadvantages or that operate only in environments such as those described above. Rather, this background is only provided to illustrate an example technology area where some implementations described herein may be practiced.

### BRIEF SUMMARY

In one implementation, a computing device is described. The computing device includes a housing having an aperture. The housing also includes a switch connected to the housing. The switch includes an activation surface. The housing also includes a button slidable within the aperture and configured to receive an activation force from a user to activate the switch. The button is moveable from an inactive position to an active position where the button activates the switch. The button has a back surface that is offset from the activation surface of the switch such that when the button is moved to the active position the activation surface and the back surface do not come into direct contact. The housing also includes an adapter positioned between the switch and the button. The adapter has a switch surface and a button surface. The button surface is aligned with the back surface of the button. The switch surface is aligned with the activation surface of the switch. The housing also includes a stabilizer arm extending from the adapter and configured to limit rotation of the button within the aperture relative to the activation force.

In one implementation, a computing device is described. The computing device includes a housing having an aperture. The computing device includes a switch connected to the housing. The switch includes an activation surface. The computing device includes a button slidable within the aperture and configured to receive an activation force from a user to activate the switch. The button is moveable from an inactive position to an active position where the button activates the switch. The button has a back surface offset from the activation surface of the switch such that when the button is moved to the active position the activation surface and the back surface do not come into direct contact. The computing device includes an adapter positioned between the switch and the button. The adapter has a switch surface and a button surface. The button surface is aligned with the back surface of the button. The switch surface is aligned with the activation surface of the switch. The computing device also includes a single stabilizer arm extending from the adapter and configured to limit rotation of the button within the aperture relative to the activation force.

In another implementation, a computing device is described. The computing device includes a switch including an activation surface. The computing device also includes a button configured to receive an activation force from a user to activate the switch. The button is moveable from an inactive position to an active position where the button activates the switch. The button has an inner surface that is offset from the activation surface of the switch such that when the button is moved to the active position the activation surface and the inner surface do not come into direct contact. The computing device also includes an adapter positioned between the switch and the button. The adapter has a switch surface and a button surface. The button surface is aligned with the inner surface of the button. The switch surface is aligned with the activation surface of the switch. The activation surface of the switch is offset from the inner surface of the button.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims, or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a front view of an implementation of the computing device;

FIG. 2 is a right, partial view of the computing device of FIG. 1;

FIG. 3 is a partial cross-sectional bottom view of the computing device of FIG. 1 in an inactive position;

FIG. 4 is a partial cross-sectional bottom view of the computing device of FIG. 1 in an active position;

FIG. 5 is a cutaway front view of the computing device of FIG. 1 in an inactive position;

FIG. 6 is a cutaway front view of the computing device of FIG. 1 in an active position;

FIG. 7 is a cutaway front view of the computing device of FIG. 1; and

FIG. 8 is a cutaway front view of another implementation of a computing device.

### DETAILED DESCRIPTION

This disclosure generally relates to devices, systems, and methods with one or more offset buttons and switches. More particularly, this disclosure generally relates to adapters and/or stabilizer bars for one or more offset buttons and switches. In some implementations, only an adapter, only a stabilizer bar, or both an adapter and a stabilizer bar may be used.

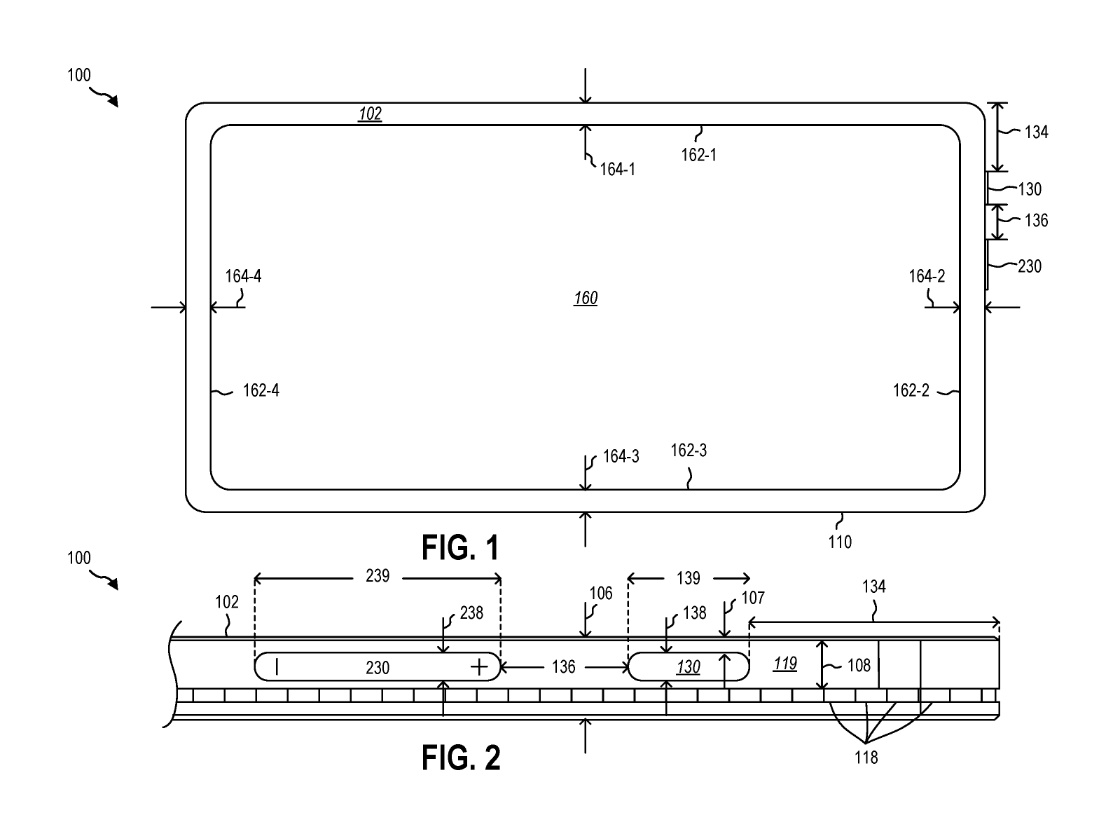

FIGS. 1 through 7 are various views of an implementation of a computing device 100. For ease of description, elements of the computing device 100 are numbered throughout FIGS. 1 through 7. These elements may be referred to generally in the description below. FIG. 1 is a front view of the implementation of the computing device 100. The computing device 100 is shown as a tablet. In other implementations, the computing device 100 may be a laptop, a hybrid computer, a smartphone, a watch, a desktop, a game controller, a camera, other computing devices, and accessories therefor. The computing device 100 has a housing 110 that houses various computing components. For example, the computing device 100 may include a processor, memory, a power source, input/output connections, communication devices, other computing components, or combinations thereof. The computing device 100 includes a front surface 102. The computing device 100 is shown with a display 160. The display 160 may include one or more edges 162. As shown, display 160 includes a top edge 162-1, a right edge 162-2, a bottom edge 162-3, and a left edge 162-4.

Displays continue to grow relative to their housings (e.g., housing 110) and gaps between displays (e.g., display 160) and housings continue to shrink. As shown, the display 160 is spaced from the housing 110 by one or more gaps 164 (e.g., top gap 164-1, right gap 164-2, bottom gap 164-3, and left gap 164-4). In some implementations, the gaps 164 may be in a range having an upper value, a lower value, or upper and lower values including any of 0.50 millimeters, 1.0 millimeters, 2.0 millimeters, 3.0 millimeters, 5.0 millimeters, 10.0 millimeters, 15.0 millimeters, 20.0 millimeters, 25.0 millimeters, 30.0 millimeters, or any value therebetween. For example, one or more gaps 164 may be greater than 5.0 millimeters. In other examples, one or more gaps 164 may be less than 20.0 millimeters. In yet other examples, one or more gaps 164 may be in a range of 1.0 millimeters to 30.0 millimeters.

The computing device 100 may include one or more buttons. As shown, the computing device 100 includes a first button 130 and a second button 230. The first button 130 may be a power button and the second button 230 may be a volume button. The first button 130 may be spaced from a top edge of the housing 110 by a distance 134. The first button 130 may be spaced from the second button 230 by a distance 136. In some implementations, the distances 134, 136 may be in a range having an upper value, a lower value, or upper and lower values including any of 1.0 millimeters, 2.0 millimeters, 3.0 millimeters, 5.0 millimeters, 10.0 millimeters, 15.0 millimeters, 20.0 millimeters, 25.0 millimeters, 30.0 millimeters, 50.0 millimeters or any value therebetween. For example, one or more distances 134, 136 may be greater than 5.0 millimeters. In other examples, one or more distances 134, 136 may be less than 20.0 millimeters. In yet other examples, one or more distances 134, 136 may be in a range of 1.0 millimeters to 30.0 millimeters. The one or more buttons 130, 230 may be slidable within an aperture 112.

FIG. 2 is a right, partial view of the computing device 100 of FIG. 1. The housing 110 may have a thickness 106. In some implementations, the thickness 106 may be in a range having an upper value, a lower value, or upper and lower values including any of 1.0 millimeters, 2.0 millimeters, 3.0 millimeters, 5.0 millimeters, 10.0 millimeters, 15.0 millimeters, 20.0 millimeters, 25.0 millimeters, 30.0 millimeters, or any value therebetween. For example, one or more thicknesses 106 may be greater than 2.0 millimeters. In other examples, one or more thicknesses 106 may be less than 20.0 millimeters. In yet other examples, one or more thicknesses 106 may be in a range of 1.0 millimeters to 30.0 millimeters.

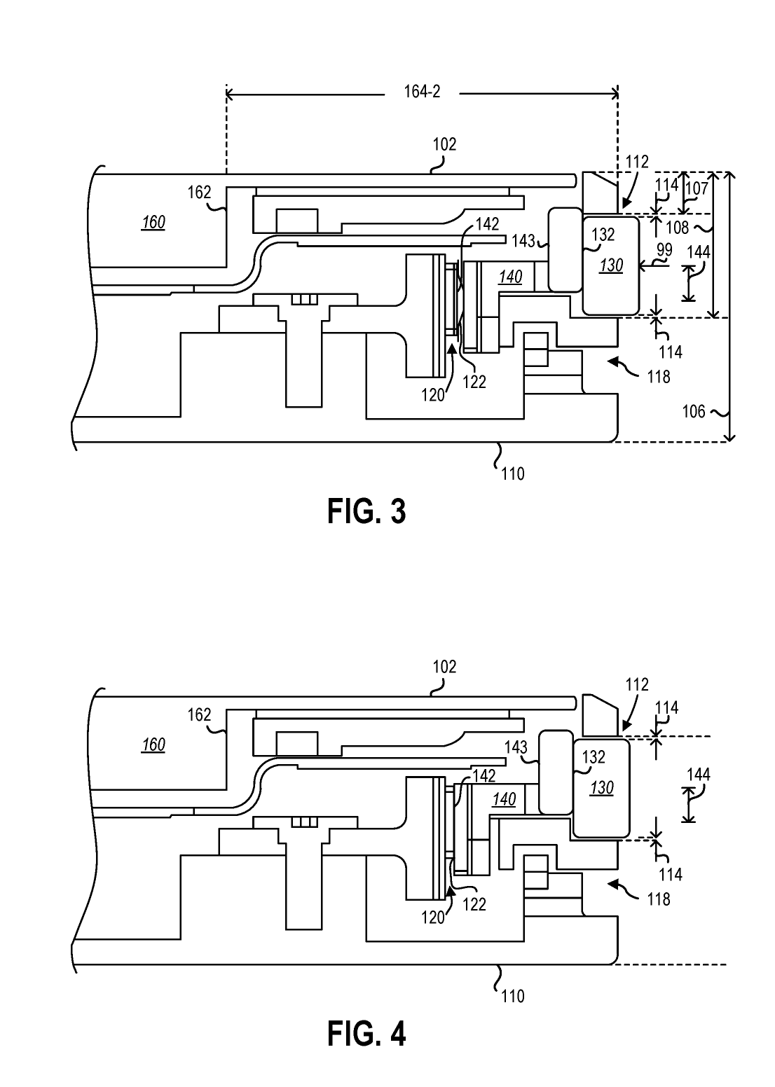

Referring briefly to FIG. 3, a partial cross-sectional bottom view of the computing device 100 of FIG. 1, as shown, the thickness 106 reduces the available space for the computing components within the housing 110. The button 130 includes a back surface 132. Typically, the back surface 132 may be aligned with and abutting an activation surface 122 of a switch 120. However, as shown, components of the display 160 prevent the back surface 132 of the button 130 from being vertically aligned with the activation surface 122 of the switch 120. In order to facilitate communication between the button 130 and the switch 120, an adapter 140 may be used. The adapter 140 may include a switch surface 142 and a button surface 143.

As shown, the housing 110 may include one or more vents 118. The vents 118 may be used to facilitate cooling of one or more computing components. The vents 118 may further limit the available space for computing components, such as the switch 120 and the button 130. For example, as shown, the vents 118 may require the button 130 to be offset (e.g., toward the front surface 102).

The switch 120 may be a dome switch. The activation surface 122 of the switch 120 may be offset from the back surface 132 of the button 130 by a distance 144. For example, the activation surface 122 of the switch 120 may be offset from the back surface 132 of the button 130 such that the activation surface 122 and the back surface 132 do not come into direct contact (e.g., do not directly touch). In some implementations, the distance 144 may be in a range having an upper value, a lower value, or upper and lower values including any of 0.25 millimeters, 0.50 millimeters, 1.0 millimeters, 2.0 millimeters, 3.0 millimeters, 5.0 millimeters, 10.0 millimeters, 15.0 millimeters, 20.0 millimeters, 25.0 millimeters, 30.0 millimeters, or any value therebetween. For example, the distance 144 may be greater than 5.0 millimeters. In other examples, the distance 144 may be less than 20.0 millimeters. In yet other examples, the distance 144 may be in a range of 1.0 millimeters to 30.0 millimeters.

The button 130 may extend through an aperture 112 in the housing 110. An activation force 99 may be applied to the button 130 to move the button 130 into the aperture 112, as shown in FIG. 4, a partial cross-sectional bottom view of the computing device 100 of FIG. 1 in an active position. As the button 130 moves into the aperture 112, the back surface 132 of the button 130 abuts the button surface 143 of the adapter 140 pushing the switch surface 142 of the adapter 140 into the activation surface 122 of the switch 120, thereby activating the switch 120. The activation surface 122 of the switch 120 may compress as shown in the activated configuration of FIG. 4.

Although only the first button 130 is shown in FIG. 3, the second button 230 may be similarly configured in cross-section. For example, the second button 230 may be movable within a second aperture (not labeled). The first button 130 is shown with substantially straight sides such that the button 130 may move out through the receptacle, absent a retention member. As shown, the button 130 may be attached to the adapter 140 and the adapter 140 may be configured to not be moveable through the aperture 112. For example, at least the width and/or height of the adapter 140 may be larger than the width and/or height of the aperture 112.

The button 130 and the aperture 112 may form one or more gaps 114. The gaps 114 may allow the button 130 to move within the aperture 112, but may also allow the button 130 to rotate about an axis running perpendicular to the activation force 99. In some implementations, rotation of the button 130 about the axis may be undesirable. Some users may consider this type of rotation as “mushy”. In some implementations, the rotation of the button 130 may affect the click ratio (e.g., (force to fire−return force)/force to fire) of the button 130.

Referring back to FIG. 2, one or more of the buttons (e.g., first button 130, second button 230) may be spaced a distance 107 from the top surface. The buttons may be positioned in an area 119 of an outer surface of the housing 110. The area 119 may be vertically (e.g., in the direction of the thickness 106 of the computing device 100) between one or more vents 118 and the front surface 102 of the computing device 100. The area 119 may have a height 108. In some implementations, the height 108 may be in a range having an upper value, a lower value, or upper and lower values including any of 1.0 millimeters, 2.0 millimeters, 3.0 millimeters, 5.0 millimeters, 10.0 millimeters, 15.0 millimeters, 20.0 millimeters, 25.0 millimeters, 30.0 millimeters, or any value therebetween. For example, the height 108 may be greater than 5.0 millimeters. In other examples, the height 108 may be less than 20.0 millimeters. In yet other examples, the height 108 may be in a range of 1.0 millimeters to 30.0 millimeters.

The buttons may have a height 138 and a width 139. In some implementations, the height 138 may be in a range having an upper value, a lower value, or upper and lower values including any of 0.5 millimeters, 0.75 millimeters, 1.0 millimeters, 1.5 millimeters, 2.0 millimeters, 3.0 millimeters, 5.0 millimeters, 10.0 millimeters, 20.0 millimeters, or any value therebetween. For example, the height 138 may be greater than 0.5 millimeters. In other examples, the height 138 may be less than 20.0 millimeters. In yet other examples, the height 138 may be in a range of 0.5 millimeters to 10.0 millimeters. In some implementations, the width 139 may be in a range having an upper value, a lower value, or upper and lower values including any of 5.0 millimeters, 7.5 millimeters, 10.0 millimeters, 15.0 millimeters, 20.0 millimeters, 25.0 millimeters, 30.0 millimeters, 35.0 millimeters, 40.0 millimeters, or any value therebetween. For example, the width 139 may be greater than 5.0 millimeters. In other examples, the width 139 may be less than 40.0 millimeters. In yet other examples, the width 139 may be in a range of 1.0 millimeters to 40.0 millimeters.

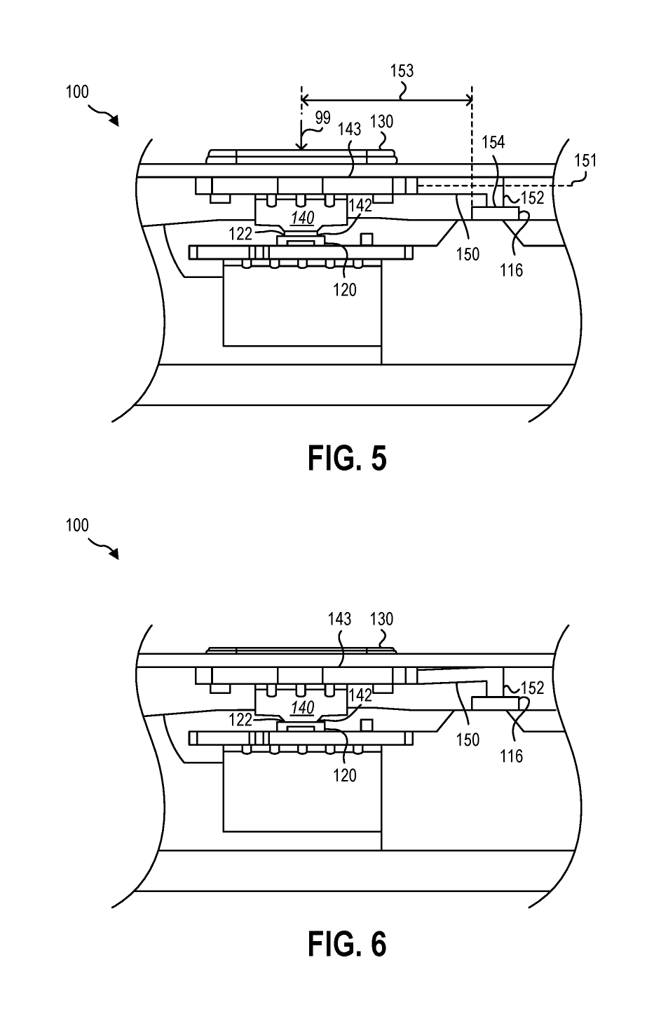

FIG. 5 is a cutaway front view of the computing device 100 of FIG. 1 in an inactive position. As shown, the computing device 100 includes a stabilizer arm 150. The stabilizer arm 150 may limit rotation of the button 130 within the aperture 112. The stabilizer arm 150 may include a longitudinal axis 151. The stabilizer arm 150 may limit rotation of the button 130 about the longitudinal axis 151.

The stabilizer arm 150 may abut a pivot point 116. In some implementations, the stabilizer arm 150 may be secured to the housing 110 by one or more of an interference fit, one or more fasteners, heat staking, welding, and adhesives. In other implementations, the pivot point 116 may be connected to the housing 110. The pivot point 116 may be offset from the direction of the activation force 99. As shown, the pivot point 116 has an offset 153 from the direction of the activation force in a range having an upper value, a lower value, or upper and lower values including any of 10.0 millimeters, 12.0 millimeters, 13.0 millimeters, 15.0 millimeters, 20.0 millimeters, 25.0 millimeters, 30.0 millimeters, 35.0 millimeters, 40.0 millimeters, or any value therebetween. For example, one or more gaps 164 may be greater than 10.0 millimeters. In other examples, one or more gaps 164 may be less than 40.0 millimeters. In yet other examples, one or more gaps 164 may be in a range of 10.0 millimeters to 40.0 millimeters. The larger the offset 153, the more the button 130 may resist rotation about the longitudinal axis 151.

The stabilizer arm 150 may include a foot 152. The foot 152 may extend away from the stabilizer arm 150. For example, as shown, the foot 152 may extend in a direction parallel to the activation force 99. The foot 152 may taper to a point 154. A tapered point 154 may facilitate limiting rotation of the button 130 while allowing the button 130 to move toward the switch 120.

The stabilizer arm 150 may be connected to the button 130 and/or the adapter 140. The stabilizer arm 150 may be integrally formed with the button 130 and/or adapter 140. As shown, the stabilizer arm 150 is a single unitary piece (e.g., is integrally formed) with the adapter 140.

As shown, the stabilizer arm 150 is a single stabilizer arm. In other words, only one stabilizer arm 150 is associated with each button 130. In other implementations, two or more stabilizer arms 150 may be associated with each button 130.

The stabilizer arm 150 may have a thickness of 2.0 millimeters. In some implementations, the thickness may be in a range having an upper value, a lower value, or upper and lower values including any of 0.5 millimeters, 1.0 millimeters, 2.0 millimeters, 3.0 millimeters, 4.0 millimeters, 5.0 millimeters, 7.5 millimeters, 10.0 millimeters, 15.0 millimeters, or any value therebetween. For example, the thickness may be greater than 0.5 millimeters. In other examples, the thickness may be less than 15.0 millimeters. In yet other examples, the thickness may be in a range of 0.5 millimeters to 15.0 millimeters.

FIG. 6 is a cutaway front view of the computing device 100 of FIG. 1 in an active position. As shown, the button 130 has been pressed into the aperture (e.g., aperture 112). The button 130 moves the adapter 140 into the switch 120. In the h122 of the switch 120, thereby activating the switch 120. As the adapter 140 moves toward the switch 120, the stabilizer arm 150 may deflect (e.g., bend). In other words, the foot 152 of the stabilizer arm 150 abuts the pivot point 116 preventing the foot 152 from moving in the direction of the activation force (e.g., activation force 99) as the adapter 140 moves toward the switch 120.

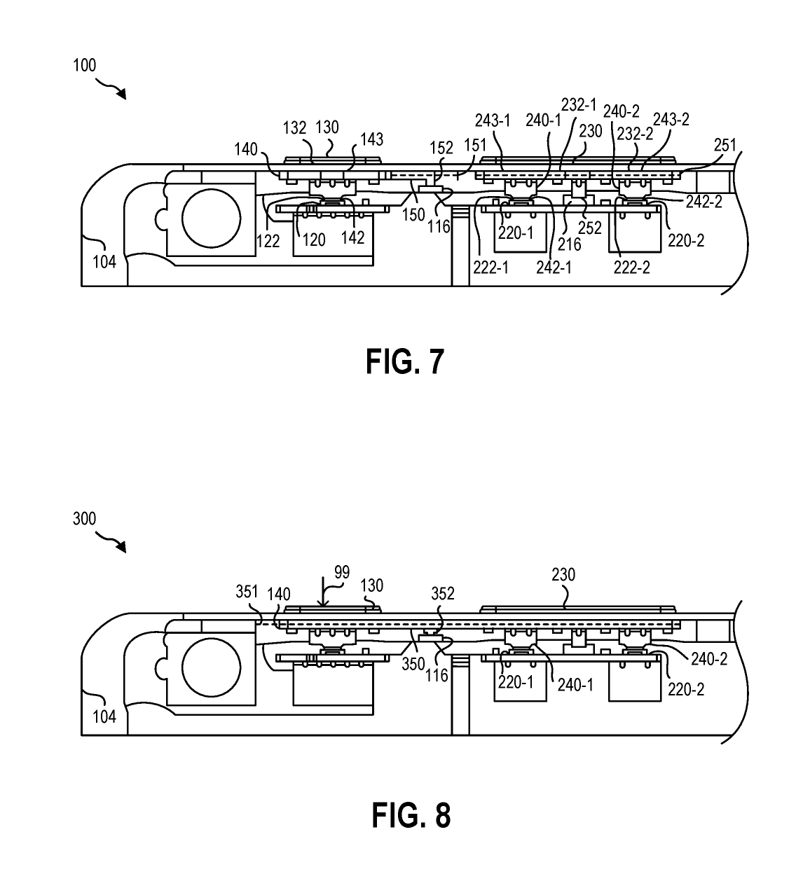

FIG. 7 is a cutaway front view of the computing device 100 of FIG. 1. As shown, the computing device 100 may include two buttons 130, 230. As with the first button 130, the second button 230 may include one or more back surfaces 232. As shown, the button 230 may include a first back surface 232-1 and a second back surface 232-2. Typically, the back surfaces 232-1, 232-2 may be aligned with and abutting an activation surface of one or more switches. As shown, the button 230 is paired with two switches 220-1, 220-2. However, one or more components of the computing device 100 may prevent the back surfaces 232-1, 232-2 of the button 230 from being vertically aligned with their corresponding activation surfaces 222-1, 222-2 of the two switches 220-1, 220-2. In order to facilitate communication between the button 230 and the switches 220-1, 220-2, one or more adapters (e.g., first adapter 240-1 and second adapter 240-2) may be used. Each of the one or more adapters 240-1, 240-2 may include a switch surface (e.g., first switch surface 242-1 and second switch surface 242-2) and a button surface (e.g., first button surface 243-1 and second button surface 243-2).

Unlike the first button 130, the second button 230 is shown without a stabilizer arm (e.g., stabilizer arm 150). Instead of a stabilizer arm, the second button 230 may be connected to a foot 252. The second foot 252 may abut a second pivot point 216. The second foot 252 may limit rotation of the button 230 about a longitudinal axis 251 of the adapter 240. In other implementations, no foot 252 may be used.

FIG. 8 is a cutaway front view of another implementation of a computing device 300. The implementation of a computing device 300 may be similar to the implementation of a computing device 100 in FIGS. 1-7. For example, the computing device 300 may include a first button 130 and a second button 230. Unlike the computing device 100 of FIGS. 1-7, the computing device 300 may include a stabilizer arm 350 between the first button 130 and the second button 230.

The stabilizer arm 350 may limit rotation of the buttons 130, 230 within an aperture (e.g., aperture 112). The stabilizer arm 350 may include a longitudinal axis 351. The stabilizer arm 350 may limit rotation of the buttons 130, 230 about the longitudinal axis 351.

The stabilizer arm 350 may abut a pivot point 116. The pivot point 116 may be connected to the housing 110. The stabilizer arm 350 may include a foot 352. The foot 352 may extend away from the stabilizer arm 350. For example, as shown, the foot 352 may extend in a direction parallel to the activation force 99. The foot 352 may taper to a point (not shown).

One or more components of the computing devices (e.g., computing devices 100, 300) described herein may be made from a variety of materials. For example, the buttons may be formed of polycarbonate acrylonitrile butadiene styrene flame retardant material (e.g., CYCOLOY CX7240 resin from Sabic Plastics). One or more stabilizer arms may be formed from a glass filled polycarbonate material (e.g., LNP THERMOCOMP Compound D551 from Sabic Plastics).

At least one implementation described herein may achieve a click ratio greater than 0.5. The click ratio may be determined by: (force to fire−return force)/force to fire.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A computing device, comprising:
a housing having an aperture;
a switch connected to the housing, the switch including an activation surface;
a button slidable within the aperture and configured to receive an activation force to activate the switch, the button moveable from an inactive position to an active position where the button activates the switch, the button having a back surface, the back surface offset from the activation surface of the switch such that when the button is moved to the active position the activation surface and the back surface do not come into direct contact;
an adapter positioned between the switch and the button, the adapter having a switch surface and a button surface, the button surface aligned with the back surface of the button, the switch surface aligned with the activation surface of the switch; and
a stabilizer arm extending from the adapter and configured to limit rotation of the button within the aperture relative to the activation force.

2. The computing device of claim 1, the aperture including one or more gaps between the housing and the button.

3. The computing device of claim 2, the one or more gaps being greater than 0.25 millimeters (mm).

4. The computing device of claim 2, the one or more gaps including a top gap and a bottom gap, the top gap and the bottom gap each being greater than 0.50 mm.

5. The computing device of claim 1, wherein the button is connected to the adapter and is configured to be removed through the aperture without the adapter.

6. The computing device of claim 1, wherein a thickness of the computing device is less than 8.0 mm.

7. The computing device of claim 1, wherein the button has a thickness of at least 5.0 mm.

8. The computing device of claim 1, wherein the housing includes one or more vents adjacent the button.

9. The computing device of claim 8, wherein the aperture of the housing is located in an area between the one or more vents and an upper surface of the computing device.

10. The computing device of claim 1, further comprising a display connected to the housing and wherein an outer edge of the display is spaced from an inner surface of the computing device by less than 30.0 mm.

11. The computing device of claim 1, wherein the back surface of the button is offset from the activation surface of the switch by a distance of greater than 1.0 mm.

12. A computing device, comprising:
a housing having an aperture;
a switch connected to the housing, the switch including an activation surface;
a button slidable within the aperture and configured to receive an activation force to activate the switch, the button moveable from an inactive position to an active position where the button activates the switch, the button having a back surface, the back surface offset from the activation surface of the switch such that when the button is moved to the active position the activation surface and the back surface do not come into direct contact;
an adapter positioned between the switch and the button, the adapter having a switch surface and a button surface, the button surface aligned with the back surface of the button, the switch surface aligned with the activation surface of the switch; and
a single stabilizer arm extending from the adapter and configured to limit rotation of the button within the aperture relative to the activation force.

13. The computing device of claim 12, wherein the stabilizer arm abuts but is not connected to the housing at a pivot point.

14. The computing device of claim 12, wherein the stabilizer arm is configured to resist rotation of the button about a longitudinal axis through the stabilizer arm.

15. The computing device of claim 12, wherein the stabilizer arm includes a foot that has a width of greater than 5.0 mm.

16. The computing device of claim 12, wherein the stabilizer arm is integrated into the button as a single unitary piece.

17. The computing device of claim 12, wherein the adapter and the button are a unitary piece that abuts the switch.

18. The computing device of claim 12, further comprising a volume button and a volume button adapter, the adapter and the volume button adapter being connected.

19. The computing device of claim 18, wherein a distance between the button and the volume button is greater than 5.0 mm.

20. A computing device, comprising:
a switch, the switch including an activation surface;
a button configured to receive an activation force to activate the switch, the button moveable from an inactive position to an active position where the button activates the switch, the button having an inner surface, the inner surface offset from the activation surface of the switch such that when the button is moved to the active position the activation surface and the inner surface do not come into direct contact; and
an adapter positioned between the switch and the button, the adapter having a switch surface and a button surface, the button surface aligned with the inner surface of the button, the switch surface aligned with the activation surface of the switch, the activation surface of the switch being offset from the inner surface of the button.
